(19) United States
(12) Patent Application Publication
(10) Pub. No.: US 2018/0181890 A1
(43) Pub. Date: Jun. 28, 2018

(54) ASSIGNMENT CREATION AND CONTRACTOR SELECTION METHOD AND SYSTEM FOR LOCATING ITEMS

(71) Applicant: Repoworks LLC, Pflugerville, TX (US)

(72) Inventors: Selene Benavides, Pflugerville, TX (US); Seth Benjamin Ruin, Bellevue, WA (US)

(21) Appl. No.: 15/851,675

(22) Filed: Dec. 21, 2017

Related U.S. Application Data
(60) Provisional application No. 62/438,090, filed on Dec. 22, 2016.

(51) Int. Cl. G06Q 10/06; G06Q 30/02; G06Q 30/06

(52) U.S. Cl. CPC G06Q 10/0631; G06Q 30/0611; G06Q 30/0206

(57) ABSTRACT

The present invention relates to a method, a system, and the associated software. With respect to the method, it is best characterized as a method of repossessing an item. The method may include receiving a request to repossess an item, a bidding process, and a confirmation of completion. The system, it is best characterized as a system for repossessing an item. In order to accomplish desired objectives, the system employs certain associated software to allow contractors to place and bid for the repossession of an item.

### CROSS-REFERENCE TO RELATED APPLICATIONS

This application claims priority to U.S. Provisional Application No. 62/438,090 filed Dec. 22, 2016. The content of the above application is incorporated by reference in its entirety.

### FIELD OF THE DISCLOSURE

The present invention relates generally to repossession contractor (“contractor”) selection, and more particularly to allowing contractors to place and bid for the specific task, selecting one of the bidders, and verifying the completion of the specific task.

### BACKGROUND

When an item is stolen, or a leased item is in payment default, the owner or a lending institution, who is entitled to the item, may commission a contractor to retrieve the item. The contractor is a person or agency who provides services to repossess items that are missing or in payment default. In order to repossess the item, the contractor needs to locate the item. Typically, the contractor has nothing more than the item holder's last-known billing address. Sometimes, this address may no longer be valid, or the item may not be kept or stored at such location. Therefore, the contractor must spend a significant amount of time and effort on locating the item. The default party may intentionally move the item to an unknown location in order to hide the item from being located, which may make the repossession processes more difficult, time consuming, and expensive. Once the item is located, the contractor may need to deliver the item to the owner or the lending institution, whose location may be located remotely.

Thus, a way to accurately detect the location of the item, alerting all parties when the item is moved, providing drop-off and pick-up locations, improving communication between the parties, providing a system to allow for a plurality of contractors to bid on specific jobs to provide competitive pricing for the owner or lending agency, and to provide a more efficient and effective system and method to return the item to the owner is desired and would save a significant amount of time and effort during the repossession process.

The disclosed system is directed to overcoming one or more of the problems set forth above.

### SUMMARY

The disclosure presented herein relates to a method, system, or computer program product. More specifically, a method, or system or computer product for contractor selection for repossession of an item. The method includes generating the requirements for repossession of an item based on the needs of a creditor or others seeking repossession of an item, collecting information about the item, locating the item, estimating the value of the item, auctioning off the task of repossessing the item to contractors, selecting a contractor to repossess the item, and receiving confirmation the item has been delivered. The system includes a processor and a memory coupled to the processor, with program instructions on the memory to receive information about the item that needs to be repossessed from a user, collect relevant information about the item that needs to be repossessed from one or more sources, determine if the item can be located, estimating the value of the item to repossess, generating an auction to allow contractors to bid on the task of repossessing the item, and confirming accepting the item from the contractor. Additionally, the disclosure also relates to a system for selling the rights to repossess vehicle, the system including a processor, and a server coupled to a network. The server receives information about an item that needs to be repossessed by a user, collects information about the item, locates the item, estimates the value of the item, auctions the task of repossessing the item to contractors, determines a contractor, and notifies the contractor of the rights to repossess the item.

In some embodiments, the preceding and following embodiments and descriptions are for illustrative purposes only and are not intended to limit the scope of this disclosure. Other aspects and advantages of this disclosure will become apparent from the following detailed description.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### DEFINITIONS

Memory refers to a computer memory, which is any physical device capable of storing information temporally or permanently. For example, Random Access memory (RAM), is a volatile memory that stores information on an integrated circuit used by the operating system, software, and hardware.

A server is a computer that provides data to other computers. It may serve data to systems on a local area network (LAN) or a wide area network (WAN) over the Internet.

A local area network may serve as few as two or three users (for example, in a small-office network) or several hundred users in a larger office. LAN networking comprises cables, switches, routers and other components that let users connect to internal servers, websites and other LANs via wide area networks.

A wide area network (WAN) is a geographically distributed private telecommunications network that interconnects multiple local area networks (LANs).

Wi-Fi is the standard wireless local area network (WLAN) technology for connecting computers and myriad electronic devices to each other and to the Internet. Wi-Fi is the wireless version of a wired Ethernet network, and it is commonly deployed alongside ethernet.

A database (DB) is an electronic filing system, generally in a computer. A collection of information (usually as a group of linked data files) organized in such a way that a program can quickly select pieces of data.

A computer network (“network”) is a group of computer systems and other computing hardware devices that are linked together through communication channels to facilitate communication and resource-sharing among a wide range of users

A computing device is any electronic equipment controlled by a CPU (Central processing Unit), including desktop and laptop computers, smartphones and tablets. It usually refers to a general-purpose device that can accept software for many purposes in contrast with a dedicated unit of equipment such as a network switch or router.

### BRIEF DESCRIPTION OF THE DRAWINGS

The preceding and following embodiments and descriptions are for illustrative purposes only and are not intended to limit the scope of this disclosure. Other aspects and advantages of this disclosure will become apparent from the following detailed description.

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 depicts a block diagram depicting a computing environment, in accordance with one embodiment of the present invention.

FIG. 2 depicts a flowchart of the operational steps taken by repossession program to locate an item, select a contractor, and confirm completion of the repossession, within computing environment 100 of FIG. 1, in accordance with an embodiment of the present invention.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “frame”, or “system.” Furthermore, aspects of the present invention may take the form of a computer program product embodied in one or more computer readable medium(s) having computer readable program code/instructions embodied thereon.

Embodiments of the present invention are related to assigning and otherwise processing repossession of items. The repossession process involves a myriad of business tasks including but not limited to registering contractors to perform the repossessions, assigning repossession assignments to the contractors, communication between all the parties involved in the repossession process, accepting the repossession assignments, conducting the repossession and contractor follow-up with the creditor issuing the repossession assignment.

Typically, communication between creditors and contractors is conducted in a manner utilizing telephones, facsimile, and emails. These conventional methods, however, tend to be redundant, time consuming, error-prone, and overall inefficient. What is needed is an online method and system for connecting these parties and providing a central location to communicate. In addition, the selection process of the contractors may be difficult if the item is in a foreign or distant location resulting in a higher cost for the creditor. If the item is constantly being moved this results in the creditor having to contact several contractors to try to find one that may reach the item and retrieve it.

In one aspect, the present disclosure is directed to a system for repossessing an item. The system may include a program configured to receive and transfer information about a specific item to be repossessed. In another aspect, the present disclosure is directed to a method of repossessing an item. The method may include receiving a request to repossess an item, a bidding process, and a confirmation of completion.

The method of repossessing an item includes a bidding process where contractors are capable of bidding on repossession of specific items, and will be rewarded with an award of contract on their winning bid. A program provides the information about the item, the auction, receiving the bids, selecting a winning bid, confirming delivery of the item, and providing the contractor with the predetermined funds for completing the repossession and charging the creditor for the work performed.

Additionally, alternate embodiments of an online method for performing these processes is provided. The method includes establishing a secure online account for a contractor wherein the online account is remotely and securely accessible by the contractor, bidding on an online auction based on items that are requested to be repossessed by creditors, delivering at least one item that was added to the contractor's online account, and receiving commissions based on the bid for completing the delivery of the item

One object of the present invention is to provide centralized administration of repossession assignments that are globally accessible by contractors. The advantage of this object is a decrease in paper handling, redundancy, inaccuracy, and general inefficiency associated with more conventional modes of communication. Another object of the present invention is to provide a more efficient system for presenting new assignments, accepting bids on the assignments, assigning the assignment to a contractor, and completing the repossession of the item. The advantage of this object is a reduction in the amount of time which transpires between the time a decision to repossess an item is made and the time the repossession ultimately takes place.

To meet these and other objects and advantages of the present invention, preferred and alternate embodiments of an online system for issuing item repossession assignments to contractors are provided. The present invention will now be described in detail with reference to the Figures.

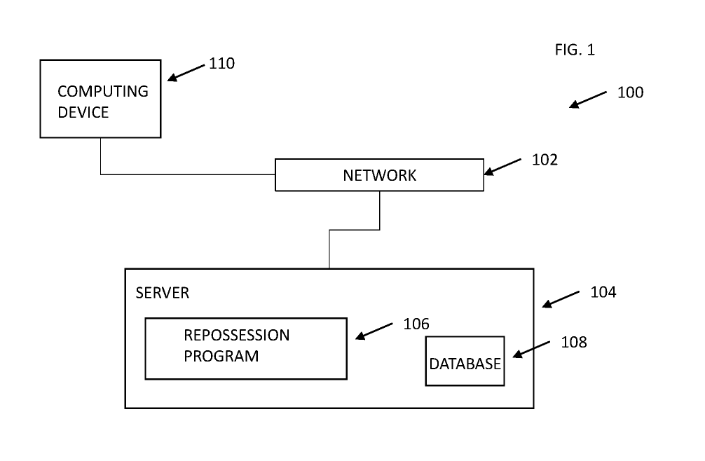

FIG. 1 depicts a block diagram of a computing environment 100 in accordance with one embodiment of the present invention. FIG. 1 provides an illustration of one embodiment and does not imply any limitations regarding the environment in which different embodiments may be implemented. In the depicted embodiment, computing environment 100 includes network 102, server 104, and computing device 110. As depicted, computing environment 100 provides an environment for repossession program 106 and database 108 to access content created on computing device 110 through network 102. Computing environment 100 may include additional servers, computers, or other devices not shown.

Network 102 may be a local area network (LAN), a wide area network (WAN) such as the Internet, any combination thereof, or any combination of connections and protocols that may support communications between server 104 and computing device 110 in accordance with embodiments of the invention. Network 102 may include wired, wireless, or fiber optic connections.

Server 104 may be a management server, a web server, or any other electronic device or computing system capable of processing program instructions and receiving and sending data. In some embodiments, server 104 may be a laptop computer, tablet computer, netbook computer, personal computer (PC), a desktop computer, or any programmable electronic device capable of communicating with computing device 110 via network 102. In other embodiments, server 104 may represent a server computing system utilizing multiple computers as a server system, such as in a cloud computing environment. In another embodiment, server 104 represents a computing system utilizing clustered computers and components to act as a single pool of seamless resources. In some embodiments, the creator of the content may provide all the potential options on server 104. In the depicted embodiment, server 104 includes repossession program 106 and database 106. In other embodiments, server 104 may include any combination of repossession program 106 and database 106.

Repossession program 106 operates to provide a system to track the repossession of an item by a selected contractor(s). Repossession program 106 creates repossession assignments, receives bids from contractors, selects a contractor, and follows the repossession to completion. In the depicted embodiment, repossession program 106 resides on server 104 with database 108 and utilizes network 102 to computing device 110 to access the content. In one embodiment, repossession program 106 resides on computing device 110. In other embodiments, repossession program 106 may be located on another server or computing device, provided repossession program 106 has access to database 108 and computing device 110.

Database 108 may be a repository that may be written to and/or read by repossession program 106. Information gathered from repossession program 106 may be stored to database 108 as well as any analyze techniques, metadata, and additional data that repossession program 106 may be used to analyze, extract, create, and associate tags in content. In one embodiment, database 108 is a database management system (DBMS) used to allow the definition, creation, querying, update, and administration of a database(s). In the depicted embodiment, database 108 resides on server 104. In other embodiments, database 108 resides on another server, or another computing device, if database 108 is accessible to repossession program 106.

Computing device 110 may be a management server, a web server, or any other electronic device or computing system capable of processing program instructions and receiving and sending data. In some embodiments, computing device 110 may be a laptop computer, tablet computer, netbook computer, personal computer (PC), a desktop computer, or any programmable electronic device capable of communicating with server 104 via network 102. In other embodiments, computing device 110 may represent a server computing system utilizing multiple computers as a server system, such as in a cloud computing environment. In another embodiment, computing device 110 represents a computing system utilizing clustered computers and components to act as a single pool of seamless resources. In the depicted embodiment, computing device 110 communicates with repossession program 106 via network 102. In other embodiments, computing device 110 may include any combination of repossession program 106 and database 108.

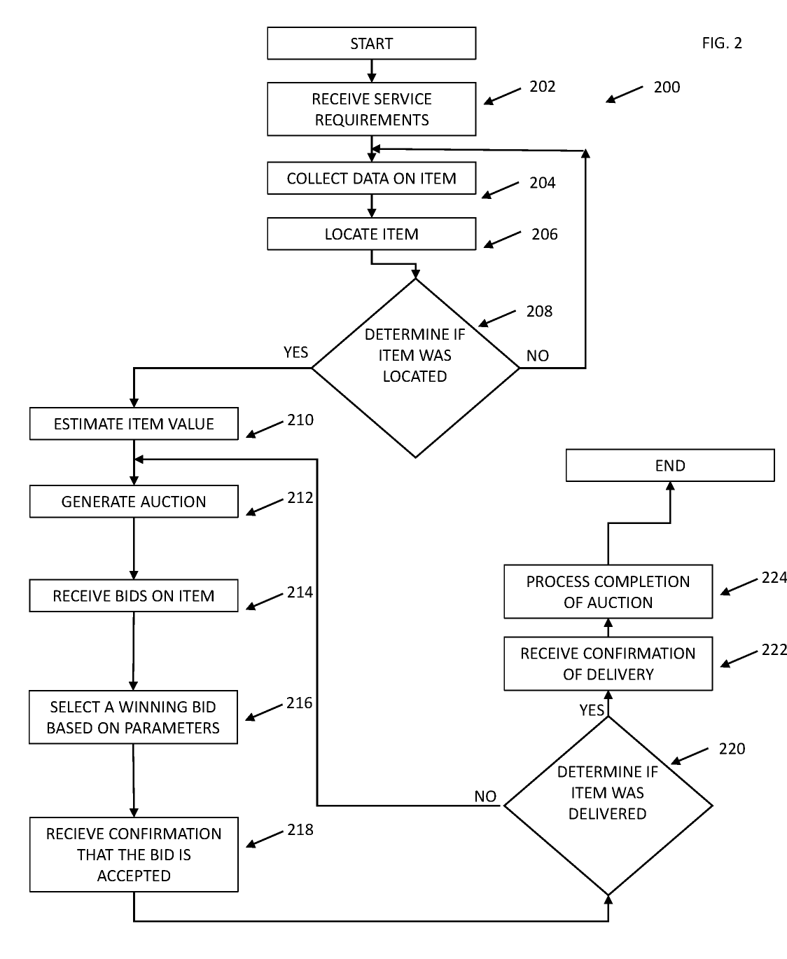

FIG. 2 depicts a flowchart of the operational steps taken by repossession program 106 to create a repossession assignment, receive bids for the assignment, assign the assignment to a contract, and follow the assignment to completion, within computing environment 100 of FIG. 1, in accordance with an embodiment of the present invention. FIG. 2 provides an illustration of one embodiment and does not imply any limitations regarding computing environment 100 in which different embodiments may be implemented. Modifications to the depicted flowchart may be made.

In step 202, repossession program 106 receives a service requirement. The repossession program 106 receives input information from the lender or creditor related to an item they want repossessed. This information may be, but not limited to the type of item, the value of the item, the importance of the item, the specified time frame for retrieval, the difficulty of locating the item, any agencies that are linked to the item, or the like. This information is used to set forth the assignment requirements. Setting forth, or generating, the assignment requirements is the process of collecting said information from the creditor or lender, or anyone who wants an item repossessed, and turning that information into the assignment requirements. The assignment requirements are then input related to several factors of the item that set forth the bidding process and potential contractors. The assignment requirements may be, but are not limited to, the intended completion date, the maximum or minimum bid requirements, the item that needs to be repossessed, the geographic location of the item, or the like.

In step 204, repossession program 106 collects data on the item that is relevant for the bidding process. Repossession program 106 performs a search into a plurality of resources to locate as much information about the item as possible. This can be performed by a web crawler, accessing one or more databased with stored information on repossessed items, such as, police data bases, repossession databases, or the like. The repossession program 106 gathers the information that is necessary to create a complete (or almost complete) profile of the item to allow the contractors who are most suited to collect the item(s) place an accurate and realistic bid. In certain embodiments, repossession program 106 may locate an item that has already been repossessed by a third party and properly documents this information to prevent the bidding on items that are no longer available or no longer need to be repossessed

In step 206, repossession program 106 locates the item to be repossessed. Repossession program 106 used the data gathered to locate the item. In some instances, the item may have been relocated, hidden, or is constantly being moved. Repossession program 106 uses the web crawler, databases, and private location services to get an approximate location of the item. Since many databases may not be updated as quickly as the item is moved, it is important to create an approximate location of the item so the proper contractors have access to the item repossession. In some embodiments, the repossession program 106 uses global positioning systems, license plate information, vehicle identification numbers, or other item specific identifying information to locate the item.

In decision 208, repossession program 106 determines if the item has been located. Repossession program 106 determines if a location of the item has been found within a predetermined tolerance. In some embodiments, the repossession program 106 needs to be within a predetermined geographic area. In additional embodiments, the repossession program 106 needs to be within a tolerance of information found via the web crawler and databases to determine a sufficient location of the item. If repossession program 106 may determine a location of the item (YES BRANCH, proceed to step 212), repossession program 106 estimates the value of the item. If repossession program 106 is unable to determine a location of the item (NO BRANCH, proceed to step 204), repossession program 106 attempts to collect more data on the item. In some embodiments, repossessions program 106 performs the collection of data step and the location step a predetermined number of times before terminating the operation.

In step 210, repossession program 106 estimates the value of the item. The estimation of the item's value is performed from the collection of data, the location of the item, the creditor's value of the item, and a plurality of factors that are used to equate a value of the item. In one embodiment, the value of the item is based on the creditor's cost and provide a margin of error for the company using the repossession program 106 based on the anticipated lowest bid. The value of the item may be, but not limited to, the remaining cost of the item, the retail value of the item, the importance of the item, the location of the item, date of receipt by the creditor, or other factors that would make an item harder or easier to get, or more important to the creditor. In some embodiments, repossession program 106 matches the value of the item based on local markets, previous values of similar items, or the like.

In step 212, repossession program 106 generates an auction for the item. The repossession program 106 creates an auction site or location (either physically or virtually) where contractors can bid on the “job” of locating and repossessing the item. The auction parameters may be, but do not have to be set to a predetermined time limit, bid maximum, bid minimum, geographic location of the bidder, geographic location of the item, or the like. In one embodiment, the auction provides to the bidders the maximum bid amount.

In step 214, repossession program 106 receives bids on the item. The bidding process allows all bidders that are within the predetermined auction parameters to enter at least one bid. The bids can be entered by users that are within the auction parameters. In some embodiments, additional bidders with consent may be able to enter a bid even though they fail to meet the auction parameters. In one embodiment, the auction receives bids for a predetermined amount of time, which may be, but not limited to hours, days, or weeks. In one embodiment, predetermined parties are notified when bids are placed.

In step 216, repossession program 106 selects a winning bid based on the parameters. The winning bid is selected either by the completion of the time frame, or a bid meeting the auction parameters. In some embodiments, a bidder places a bid that is below the minimum bid, they are automatically awarded the auction. In additional embodiments, the auction may stay open till the time has expired and select a winner based on the totality of the circumstances regarding each bidder. In one embodiment, a winning bid is selected based on when the bid was placed, the lowest bid, or other variables which are set by repossession program 106. In some embodiments, the winning bid is manually selected.

In step 218, repossession program 106 receives confirmation from the winning bidder that they have accepted the bid. In some embodiments, the winning bidder must accept the approval of their bid to finalize the auction. In some embodiments, there is a window of time for the winner to accept the bid. In some embodiments, if the winner does not confirm they will take the job, the auction is reactivated and allow new bids to be placed. In some embodiments, there are rules applied to winning the auction, such as the item remaining within the set geographic area, and if the item is moved to a new area the winner can retract their bid. The winning bidder is then given the parameters related to the item, location, time frame, and the like.

In decision 220, repossession program 106 determines if the item was delivered to the predetermined location. Once the contractor that wins the bid and accepts the bid, they are required to locate and return the item to a predetermined location. In some embodiments, this is within a predetermined time frame. In some embodiments, this time frame is adjustable based on, but not limited to, the item being relocated, the difficulty of retrieving the item, or difficulty acquiring the necessary requirements to gather the item (e.g. warrants), at which time the time frame may be adjusted to accommodate these and other factors via communication between the parties, or supply the repossession program 106 with this information. If the repossession program 106 determines that the item was delivered (YES BRANCH, proceed to step 222), the repossession program 106 receives confirmation that the item was delivered. If the repossession program 106 determines that the item was not delivered (NO BRANCH, proceed to step 212), the repossession program 106 generates another auction.

In step 222, repossession program 106 receives confirmation the item was delivered. This confirmation may be in the form of a third party reporting the item has been delivered, the contract supplying predetermined information that the item was delivered, the creditor contacting the auctioneer to determine the item was delivered, or the like. The confirmation is required to begin the transfer of the fees from the creditor to the contractor.

In step 224, repossession program 106 processes the completion of the auction. The repossession program 106 closes out the auction, supplies the contractor with their bid value, contacts the creditor that the item has been delivered, and provides all necessary information to other agencies or authorities (e.g. local police departments, state police department, etc.) that the item has been repossessed and delivered to the necessary party. In some embodiments, the contractor is supplied the bid value within a predetermined time (e.g. 2-3 weeks) after the close of the auction. In additional embodiments, repossession program 106 archives the reports, the auction, the parties involved, and other information that is relevant to the auction.

The present invention may be a system, a method, and/or a computer program product. The computer program product may include a computer readable storage medium (or media) having computer readable program instructions thereon for causing a processor to carry out aspects of the present invention.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or additional freely propagating electromagnetic waves, electromagnetic waves propagating through a waveguide or additional transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In additional embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, special purpose computer, or additional programmable data processing apparatus to produce a machine, such that the instructions, which execute via the processor of the computer or additional programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or additional devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, additional programmable data processing apparatus, or additional device to cause a series of operational steps to be performed on the computer, additional programmable apparatus or additional device to produce a computer implemented process, such that the instructions which execute on the computer, additional programmable apparatus, or additional device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or table of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

1. A method for contractor selection for repossession of an item performed by one or more data processing apparatuses, the method comprising:
generating one or more requirements to repossess one or more items based on information provided by one or more users;
collecting a plurality of information about the one or more items;
locating the one or more items based on the information provided by one or more users;
estimating the value of the one or more items based on the geographic location and the plurality of information collected;
auctioning the task of repossessing the one or more items to a plurality of contractors;
selecting a contractor to complete the task of repossessing the one or more items; and
receiving confirmation that the item has been delivered to a predetermined geographic location.

2. The method of claim 1 further comprising:
supplying the contractor with a commission based on the bid placed by the contractor in the auction.

3. The method of claim 1 wherein the item identifying information is at least one of the following: vehicle identification numbers, license plate information, information provided by a lean holder, information provided by the user seeking repossession.

3. (canceled)

4. The method of claim 1 wherein said one or more requirements includes at least one of the following: the competition date, the bidding requirements, and the geographic location of the item.

5. The method of claim 1 wherein if the one or more items cannot be initially located inside the intended geographic region, more information about the item is collected.

6. The method of claim 5 wherein after collecting more information about the item, the intended geographic region is updated.

7. The method of claim 1 wherein said plurality of information used in said estimating the value of the item includes the distance of the one or more items from the user seeking repossession of the item.

8. The method of claim 1 wherein the auctioning of the task to repossess the one or more items is a bidding process, wherein the highest bidder wins.

9. The method of claim 1 wherein the auctioning of the task to repossess the one or more items is offered only to contractors within a geographic location close to the item.

10. The method of claim 1 wherein the auctioning of the task to repossess the one or more items is offered on a first contractor to accept the task wins basis.

11. The method of claim 1 wherein the auctioning of the task to repossess the one or more items further comprises the parameters of the time limit of the auction, the maximum and minimum bid limits, and the geographic location limit of the item.

12. The method of claim 11 wherein the auction of the task to repossess the one or more items only accepts bids that are within the limits of the parameters.

13. The method of claim 1 wherein the contractor is selected by winning said auctioning of the task to repossess the one or more items.

14. The method of claim 13 wherein said winning said auctioning of the task to repossess the one or more items is accomplished by being the highest bidder at the completion of a predetermined time frame, or placing a bid meeting predetermined auction parameter.

15. The method of claim 13 wherein the selected contractor must accept the approval of their bid to finalize the auction.

16. (canceled)

17. (canceled)

18. (canceled)

19. (canceled)

20. (canceled)

21. The method of claim 1 wherein said one or more items is located using at least one of the following: global positioning systems, license plate tracking information, and internet web crawlers.

22. A non-transitory computer readable medium storing a program which when executed by at least one processing unit of a computing device provides uniform conveyance apparatuses maintenance, the program comprising instructions for:
receiving information regarding a request by a user to repossess an item;
collecting relevant information about the item that needs to be repossessed from one or more sources;
determining if the item that needs to be repossessed can be located;
estimating a value of the item to repossess based on the value of said item and the location of said item;
generating an auction to allow one or more contractors to bid on or accept the task of repossessing the item; and
confirming acceptance of the item from the contractor.

23. The non-transitory computer readable medium of claim 22 wherein after said accepting the from the contractor, the contractor is supplied the bid value.

24. The non-transitory computer readable medium of claim 22 further comprising:
a server capable of crediting a contractor account a payment.

25. A system for selling the rights to repossess a vehicle; comprising:
a processor; and
a server coupled to a network; wherein the server receives information about an item that needs to be repossessed by the user, collects information about the item from one or more sources, locates the item, estimates a value of the item based on the geographic location of the item, auctions the task of repossessing the item to a plurality of contractors, determines a contractor of the rights of repossessing the item, and notifies the contractors of the rights to repossessing the item over the network.
